(19) United States
(12) Patent Application Publication
(10) Pub. No.: US 2008/0017592 A1
(43) Pub. Date: Jan. 24, 2008

(54) FILTER ELEMENT FOR A FILTER PRESS PLATE

(76) Inventors: Christoph Maurer, Zurich (CH); Hansjoerg Duer, Schwarzach (AT); Richard M. Gaiser, Pendleton, NY (US)

Correspondence Address: SPENCER, FANE, BRITT & BROWNE, 1000 WALNUT STREET, SUITE 1400, KANSAS CITY, MO, 64106-2140, US

(21) Appl. No.: 11/766,885

(22) Filed: Jun. 22, 2007

Related U.S. Application Data
(60) Provisional application No. 60/805,840, filed on Jun. 26, 2006.

(30) Foreign Application Priority Data
Nov. 16, 2006 (EP) 06 023 831.8

(51) Int. Cl. B01D 25/12; B01D 37/00

(52) U.S. Cl. 210/767; 210/433.1; 210/487

(57) ABSTRACT

The invention relates to a filter element for a filter press plate, having two filter areas and a passage for passing through a liquid to be filtered and by means of which the two filter areas are interconnected. According to the invention it can be provided that the passage is constructed in modular manner with at least two separate flange elements, each of said flange elements having a passage opening for the liquid to be filtered and in which one of the two filter areas is located on each of the two flange elements and that connecting means are provided with which the two flange elements are interconnected when the passage openings are aligned.

### RELATED APPLICATIONS

The present U.S. non-provisional patent application claims priority benefit of an earlier filed U.S. provisional patent application titled ADJUSTABLE BARREL-NECK CONNECTOR, Ser. No. 60/805,840, filed Jun. 26, 2006, and an earlier-filed European patent application titled FILTER ELEMENT FOR A FILTER PRESS PLATE, application No. EP 06 023 831.8, filed Nov. 16, 2006. The identified earlier-filed patent applications are incorporated by reference herein.

### FIELD OF INVENTION

The invention relates to a filter element for a filter press plate, having two filter areas and a passage for passing through a liquid to be filtered, by means of which the two filter areas are interconnected.

### BACKGROUND OF INVENTION

Filter press plates for plate filter presses are known. Such filter press plates generally have a centrally positioned flow opening used for the passage of the liquid to be filtered. In the plate filter press several filter press plates are so juxtaposed and pressed that the flow openings are aligned and form a channel by means of which the liquid to be filtered is fed into the filter.

A flexible passage tube for fixing the filter areas in the vicinity of the flow opening is e.g. known from U.S. Pat. No. 6,932,906 B2. At its opposite front ends the known passage tube has in each case a flange on which a filter area is located.

For installing a known filter element in a filter press plate it is necessary to push and/or pull one of the two filter areas through the flow opening of the filter press plate, the other filter area being left behind the flow opening. To be able to position the passage tube with its flange sections in the flow opening it is deformed during pushing or pulling through.

In the fitting of the known filter element it is consequently necessary to fold, roll together or otherwise compress at least one filter area to such an extent that it fits through the flow opening. This procedure can be relatively complex particularly with large-area and/or relatively inflexible filter areas.

### SUMMARY OF INVENTION

The object of the invention is to provide a filter element for a filter press plate which, in the case of high reliability and economy can be fitted particularly easily on a filter press plate.

According to the invention this object is achieved by a filter element having the features of claims 1 or 16. Preferred embodiments are given in the dependent claims.

According to one aspect of the invention a filter element is characterized in that the passage is constructed in modular manner with at least two separate flange elements, each of said flange elements having a passage opening for the liquid to be filtered and whereas on the flange elements is in each case located one of the two filter areas, and that connecting means are provided with which the two flange elements are interconnected when the passage openings are aligned.

A fundamental idea of the invention is considered to be the construction of the passage in multipart manner with at least two separate elements, whereas on each element is in each case fixed one of the two filter areas. The elements can be interconnected by connecting means. Such an arrangement makes it possible to join together the passage in situ at the time of installing the filter element on the filter press plate, i.e. the two filter areas are only interconnected during the installation of the filter element on the filter press plate by means of the passage. Thus, on fitting the filter element it is unnecessary to feed one of the two filter areas through the filter press plate, so that a particularly simple and economic installation is possible. In particular there is no need for a complex folding of one of the filter areas and potential damage of it associated with the folding and/or passage of the filter area is avoided.

The connecting means are appropriately constructed in such a way that they permit a connection of the two flange elements without using tools. Preferably the connecting means are so designed that it is possible to bring about a connection between the two flange elements by relative movement of the flange elements towards one another, particularly by compression or rotation. The connecting means can e.g. be provided for a positive and/or a non-positive connection.

In particularly preferred manner the connecting means have a connecting tube on which the two flange elements are located. According to this embodiment the passage is constructed with a further element, the connecting tube, on which is fixed on the one hand the first flange element and on the other the second flange element, so that the two flange elements are interconnected via the connecting tube. Additionally or alternatively the connecting means can have elements for the direct connection between the two flange elements. A connecting tube can in particular be use for compensating diameter and/or thickness differences of the filter press plate. A connecting tube more particularly makes it possible to adapt the filter element to different plate thicknesses in a simple manner. Thus, the connecting means can e.g. be so constructed that the flange elements can be fixed to the connecting tube with differing mutual spacing. It is e.g. possible to provide externally on the connecting tube and/or on the flange elements a plurality of locking devices, which maintain the flange elements on the connecting tube with a differing mutual spacing. Preferably on the connecting tube there is provided at least one stop, particularly a stop ring, which limits a relative movement of at least one flange element with respect to the connecting tube.

Advantageously a projecting portion of the connecting tube projecting out of one or both flange elements is removed, e.g. by cutting off.

The connecting tube can also have a variable length in order to compensate differing thicknesses in the filter press plate. For this purpose the connecting tube can e.g. have a flexible material and/or be constructed in bellows-like manner.

The connecting means are preferably so constructed that the two flange elements are interconnected in a rotary fixed manner, particularly in a defined rotary position. This permits a directional installation of the two filter areas in which they are from the outset positioned in their desired location without any angular displacement and in which they cover to an optimum extent the filter press plate. For bringing about the defined rotary position the connecting means appropriately have at least one positioning element. The positioning element can e.g. be an axially directed projection and/or an axially directed groove, which is provided on one of the flange elements and/or on the connecting tube and which is in engagement with a corresponding element on the adjacent flange element and/or on the adjacent connecting tube. Such an additional positioning element is particularly advantageous if the connecting means have a snap closure such that a turning of the two flange elements against one another would be fundamentally possible. To ensure a subsequent alignment of the filter areas, basically, it is also possible for the two flange elements to be rotatable relative to one another.

If a connecting tube is provided, it is advantageous according to the invention for the flange elements to be positioned radially externally on the connecting tube. In this embodiment the flange elements are slided over the connecting tube. A passage channel through the passage can in this case be formed by an inner wall of the connecting tube, i.e. the inner wall of the connecting tube is in contact with the liquid flowing through the passage. In this case the inner walls of the flange elements abut the connecting tube.

However, it is alternatively possible for the passage channel to be formed both by the inner wall of the connecting tube and by the inner walls of the flange element. To obtain a particularly homogeneous flow pattern, it is advantageous for the inner walls of the flange elements to be at least zonally aligned with the inner wall of the connecting tube. According to this embodiment in the cross-section of the passage channel there are no discontinuities on passing from the channel area formed by the flange elements to the channel area formed by the connecting tube, so that the flow resistance is particularly low.

The connecting means can e.g. have a screw closure or a bayonet catch, which can be brought into a secured position by rotation and can be released by an opposing rotation. However, it is particularly preferred for the connecting means to have at least one snap closure. The snap closure can e.g. be constructed for connecting together the flange elements or optionally for connecting the flange elements to the connecting tube. The snap closure preferably has at least one deformable and/or movable profile element, which is received in a corresponding depression. For example, at least one ring-shaped profile element can be provided. However, it is particularly preferred for the profile element constructed as a snap element and in particular also the corresponding depression to have a narrow width compared with the circumference of the passage. This leads to a particularly good sealing action. The snap element and in particular also the corresponding depression can e.g. be segmentally constructed. Preferably on the circumference of the passage there are provided several segmental profile elements and/or depressions. Preferably, in one segment there can be particularly provided in each case in axially displaced, superimposed manner a plurality of profile elements and/or depressions. There can also be provided several segments. Alternatively or additionally to snap elements and/or depressions, which extend along a partial area of the circumference of the flange elements and/or connecting tube, there can be provided ring-like snap elements or alternatively depressions, which pass round the complete circumference.

Appropriately the profile element of the snap closure is bendably constructed as a bending snap element. In particular the snap closure can have at least one radially acting bending snap element. This can in particular be understood to mean such an element which can be moved radially with respect to the passage channel formed in the passage by bending action. Basically, tangentially acting snap elements are also possible.

Advantageously the connecting means, particularly the snap closure element, are so designed that a non-destructive release of the connection between the two flange elements is possible. This can be brought about by choosing a suitable angle on the snap element. This permits a particularly easy dismantling of the filter element from the filter press plate. For dismantling purposes the passage can also be constructed at least zonally in a flexible manner.

Another preferred embodiment of the invention consists in the fact that the snap closure has a plurality of in particular axially displaced profile elements, which are preferably positioned radially inwardly on at least one of the flange elements and/or radially outwardly on the connecting tube. Such an embodiment makes it possible to secure the flange element in a plurality of axial positions. In turn this makes it possible to adapt the passage length to the filter press plate thickness.

It is e.g. possible according to the invention for at least one of the flange elements to be positioned frontally on the connecting tube and in particular have a disk-shaped construction. In particular, in this case a particularly reliable connection is obtained in that the snap closure has at least one profile element located frontally on the connecting tube and which preferably passes through one of the flange elements. Appropriately the profile element projects axially on the connecting tube.

It is particularly advantageous for the passage to be sealed against a radial passing through of liquid. A radial passage of liquid can in particular be understood to mean a passage through the wall of the passage transversely to the passage longitudinal direction. For sealing purposes it is e.g. possible to provide in each case at least one sealing element between the individual flange elements and/or between the flange elements and the connecting tube.

The effectiveness of the filter element can be further increased by providing a sealing element, particularly a sealing ring between at least one of the flange elements and the connecting tube. This makes it possible to seal transitions between the flange element and the connecting tube and prevent an undesired flow through the wall of the multipart constructed passage. The sealing element is appropriately constructed as an elastomer seal and is preferably located in the connecting area between adjacent elements.

The sealing element can e.g. be injection moulded onto the flange element. This is particularly advantageous if, besides the sealing element, the flange element has further elastomeric areas. However, the sealing element can e.g. also be received in a corresponding groove on the flange element or on the connecting tube.

A particularly long service life can be brought about in that at least one filter area is connected by means of a preferably ring-like adapter element to the passage, particularly the flange element. This can be regarded as an independent inventive aspect. In particular, the adapter element can be constructed flat and/or as a cloth, e.g. as a fabric and/or film. According to this embodiment the filter area is not directly connected to the passage. Instead the filter area is fixed to an adapter element, which is in turn connected to the passage. The adapter element is preferably made from a different material compared to the adjacent passage area. However, there can also be provided an integrated construction, where the filter areas are directly connected to the flange elements and for which in particular an adhesive integral and/or firmly bonded joint can be provided.

It is possible according to the invention for at least one of the two filter areas or optionally the adapter element to be adhesively and/or integrally joined and/or firmly bonded to the passage, particularly by welding and/or bonding. A connection can in particular be produced by laser welding and/or ultrasonic welding. Preferably, it can be provided that the material of the passage penetrates the filter area or adapter element.

A particularly reliable connection between passage and filter area is obtained if for fixing at least one filter area and/or adapter element to the passage on the latter is provided at least one retaining spike which perforates the filter area or adapter element. By means of said retaining spike the positive connection between filter area or adapter element and passage is brought about. Though, it is advantageous for the retaining spike to taper and in particular have a conical construction. This facilitates the perforation of the filter area during production. If the filter area or adapter element has a fabric, the retaining spike is appropriately so dimensioned that it penetrates, but does not damage the fabric. For this purpose it is advantageous for the retaining spike diameter to be smaller than the fabric mesh width. However, the spike can also be dimensioned in such a way that it widens the mesh of the fabric which it penetrates.

A particularly easily producible and at the same time reliable fixing of a filter area to the passage is obtained in that at least one of the flange elements has a two-part construction, particularly with a retaining ring and a fixing ring, and that in particular one of the two filter areas and/or the adapter element is received between the two parts and is fixed to the flange element. In this embodiment the flange element runs in the vicinity of the fixing on both flat sides of the filter area or adapter element, so that the fixing means are protected by the flange element. In particular, the retaining ring and fixing ring can be connected preferably adhesively, integrally and/or firmly bonded by means of the retaining spike.

The economics can be inventively increased in that the two flange elements have the same construction. In this case only one type of flange element has to be stocked.

Advantageously the passage has a plurality of wall thickness reductions for increasing flexibility. The wall thickness reductions can be provided in a tubular area and/or in a radial area of the passage. Additionally or alternatively with respect to the wall thickness reductions, notches can also be provided. The wall thickness reductions appropriately extend axially of the passage.

The term filter area can in particular relate to a filter cloth, e.g. a filter fabric, a filter fibre non-woven and/or a filter diaphragm. The two filter areas can be constructed separately, but basically also continuously, particularly in one piece. As a result of the modular structure of the passage there is no need to pass a filter area through the flow opening of the filter press plate during the installation of the filter element. Thus, it is e.g. possible to run a continuous filter cloth around a filter press plate, so that said filter cloth on either side of the filter press plate in each case forms a filter area, the two filter areas being additionally interconnected via the passage.

Appropriately the passage is made from a plastics material, particularly a thermoplastic material. The inventive passage can also be referred to as a barrel neck.

According to another aspect of the invention a filter element can be characterized in that the passage has two terminal flange areas on which the filter areas are located and an intermediate central area, the passage having a higher flexibility in at least one of the flange areas than in the central area.

According to this inventive aspect the passage in the flange areas securing the passage in the filter press plate and which for this purpose have a larger cross-section than the central area is more flexible than in the central area used for passing through the liquid to be filtered. Thus, there is provided a planned flexibility in the areas which must be deformed for fitting or dismantling the passage in or out of the filter press plate, whereas in the areas where no deformation is needed the flexibility is less. This leads to an easily fitted and dismantled filter element, which in the case of high reliability can also be used for high operating pressures.

A preferred embodiment of the invention is that the passage in the flange area has a different material to that in the central area. Thus, according to this embodiment the different flexibility is made available through a different material composition.

It is alternatively or additionally possible to provide at least one film hinge for increasing flexibility in the flange area. In this case the flexibility rise results from a wall thickness reduction. According to this embodiment the passage e.g. can have in the central area a tubular element on which are frontally provided in the flange area a plurality of tongues, which can in each case be bent via a film hinge for forming a flange. There, the film hinge makes it possible to so position the tongues on passing the passage through the filter press plate that they are located within the tubular element cross-section and in any case do not prevent the movement of the tubular element through the filter press plate. After sliding through the passage the tongues can be bent in such a way that the cross-section is widened so far that a retraction of the passage through the filter press plate is no longer possible. For securing the tongues in the bent position they can e.g. be connected to one of the filter areas and/or can be secured by a locking ring.

Appropriately the filter areas are in each case provided with at least one hole, the filter areas being fixed to the passage in the vicinity of the hole. Preferably the holes in the filter areas are aligned with the passage openings of the flange elements.

Another aspect of the invention is constituted by a method for filtering a liquid, by which the liquid is passed through the filter areas of an inventive filter element.

### BRIEF DESCRIPTION OF THE DRAWING FIGURES

The invention is described in detail hereinafter by preferred embodiments relative to the attached diagrammatic drawings, wherein show:

FIG. 1 is a perspective view of a first embodiment of an inventive filter element;

FIG. 2 is a plan view of the filter element of FIG. 1;

FIG. 3 is a longitudinal sectional view of the filter element of FIG. 1;

FIG. 4 is a longitudinally sectioned detail view of another embodiment of an inventive filter element in the vicinity of the passage;

FIG. 5 is another embodiment of an inventive filter element in side view;

FIGS. 6 to 11 is another embodiment of an inventive filter element at different stages of installation on a filter press plate;

FIGS. 12 and 13 is further embodiments of inventive filter elements in longitudinally sectioned detail views;

FIG. 14 is another embodiment of a passage for an inventive filter element in perspective view prior to joining together;

FIG. 15 is another embodiment of an inventive filter element in longitudinally sectioned detail view;

FIGS. 16 and 17 is another embodiment of an inventive filter element in longitudinally sectioned detail view before and after fixing to the filter area; and

FIG. 18 is a plan view of the filter element of FIG. 17.

Identical or similarly acting elements carry the same reference numerals in all the figures.

### DETAILED DESCRIPTION OF THE INVENTION

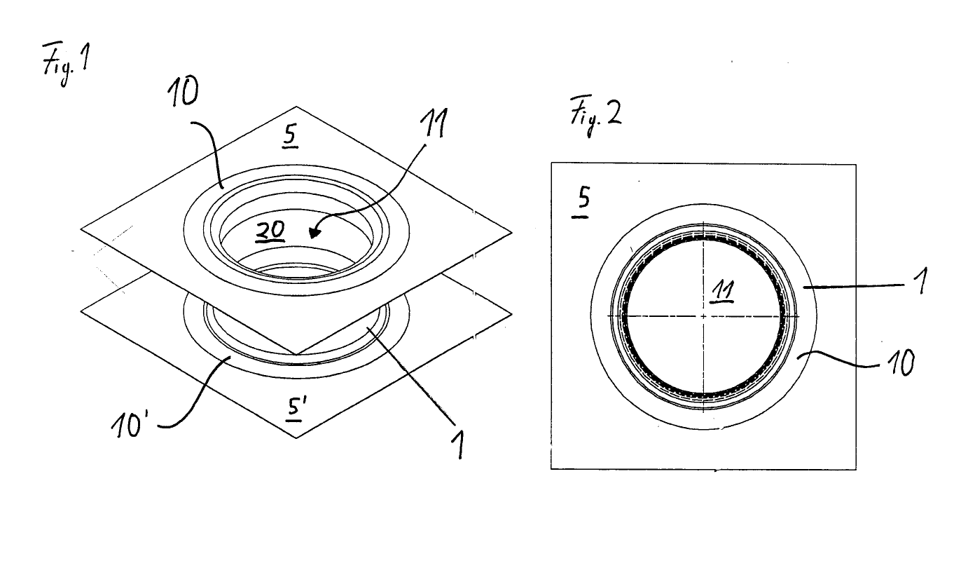

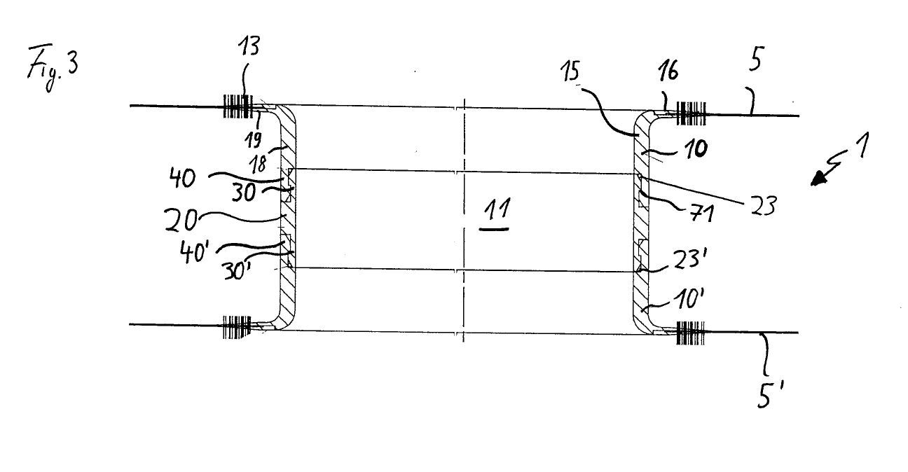

A first embodiment of a filter element according to the invention is shown in FIGS. 1 to 3. The filter element has two flat, roughly parallel filter areas 5, 5′, in the form of filter cloths, which in each case have a hole. In the vicinity of their hole edge the two filter areas 5, 5′ are fixed to a tubular passage 1. In passage 1 is formed a passage channel 11, which extends through passage 1 and filter areas 5, 5′ and which is used for passing a liquid through during the operation of a filter plate press.

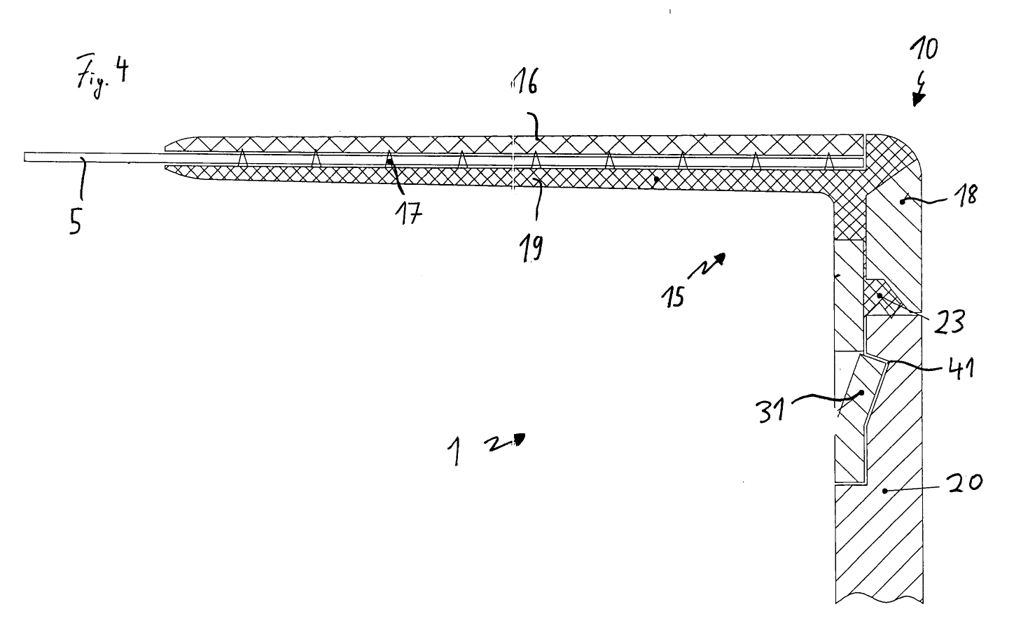

The detailed construction of passage 1 is in particular visible in FIGS. 1 and 3. Passage 1 has two separate flange elements 10, 10′, the filter area 5 being located on flange element 10 and filter area 5′ on flange element 10′. The two flange elements 10, 10′ have an identical construction. As a result of the identical construction only flange element 10 is described in detail hereinafter.

Flange element 10 has a two-part construction and is provided with a retaining ring 15 and a disk-like fixing ring 16. The retaining ring 15 comprises an axially directed, roughly sleeve-shaped tubular section 18, to the front of which is connected a radially directed, ring-disk-shaped flange section 19. Fixing ring 16 also runs radially and facing flat flange section 19 of retaining ring 15. The filter area 5 is received between fixing ring 16 and flange section 19 of retaining ring 15 and is fixed by a seam or weld 13 to retaining ring 15 and fixing ring 16.

Between the two flange elements 10, 10′ is provided a connecting tube 20 interconnecting the two flange elements 10, 10′. Connecting tube 20 and flange elements 10, 10′ are constructed with the same internal cross-section, so that no cross-sectional changes arise in the passage channel 11 on transition between connecting tube 20 and flange elements 10, 10′.

A profile element 30 projecting axially from connecting tube 20 is provided on the front of the connecting tube 20 for connecting flange element 10 to connecting tube 20. A corresponding profile element 40 projects axially and frontally from tubular section 18 of flange element 10. Between the ring-shaped profile elements 30 and 40 a snap closure is provided on a step 71 and fixes flange element 10 to passage channel 20. Analogically constructed profile elements 30′ and 40′ are provided on the opposite front side of the connecting tube 20 and on the second flange element 10′, respectively. For sealing the connection between flange element 10 and connecting tube 20 a sealing ring 23 is provided in the vicinity of profile elements 30 and 40. An analogously constructed sealing ring 23′ is arranged between connecting tube 20 and the second flange element 10′.

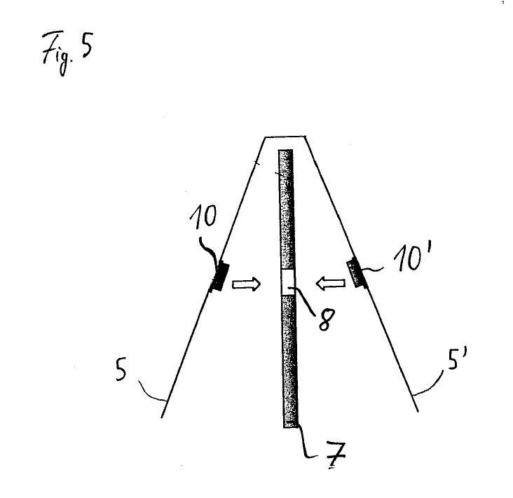

FIG. 4 shows another embodiment of an inventive filter element with a differently constructed passage 1 in the form of a broken longitudinal sectional view. In the embodiment of FIG. 4 on the sleeve-like tubular section 18 of retaining ring 15 is provided a profile element 31 constructed as a radially acting bending snap element, which for connecting flange element 10 and connecting tube 20 engages in a corresponding depression 41 in the radially outwardly located wall of connecting tube 20.

In its tubular section 18 and its flange section 19 retaining ring 15 has materials of differing rigidity. In tubular section 18, particularly in its areas in which is established a retaining function with respect to connecting tube 20, a comparatively rigid, less flexible material is used. However, in flange section 19 use is made of a comparatively more flexible, more deformable and less rigid material and in particular an elastomer can be used here.

Between connecting tube 20 and tubular section 18 of retaining ring 15 is provided a sealing ring 23 which can be made from the same material as flange section 19.

For fixing filter area 5 to flange element 10 a plurality of retaining spikes 17 are provided in the flange section 19 of retaining ring 15 and penetrate the flat filter area 5 and consequently positively retain the same. At their tips the spikes 17 are integrally welded to fixing ring 16, which consequently secures filter area 5 on spikes 17.

Fixing ring 16 also has a high flexibility material. In particular, the fixing ring 16 and/or retaining ring 15 can be made in the vicinity of flange section 19 from a thermoplastic elastomer. This makes it possible to partially reshape the passage 1 during the dismantling of the filter element. As material for the rigid tubular section 18 can e.g. be used polypropylene with a fibre glass reinforcement.

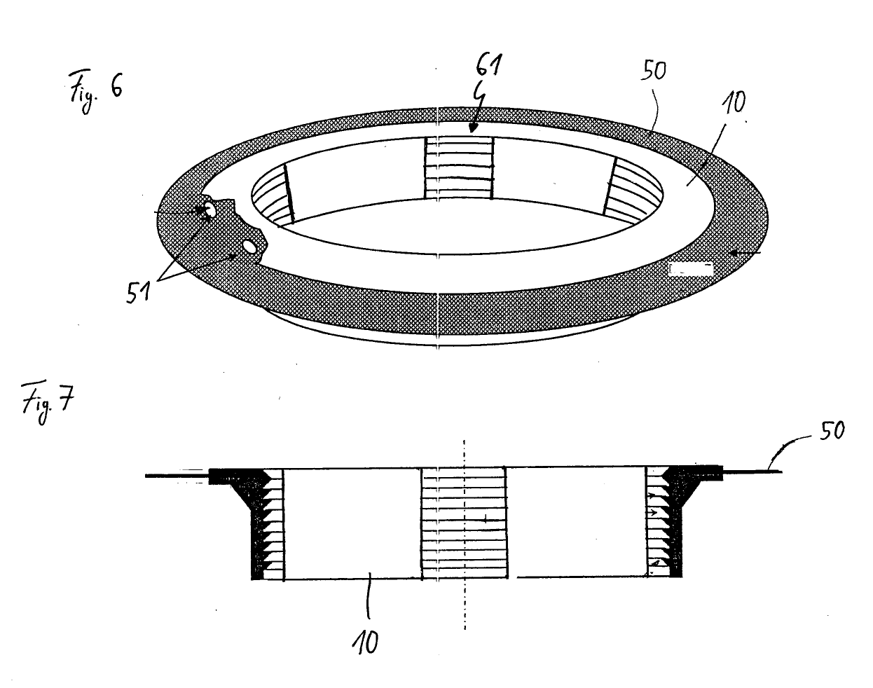

Another embodiment of an inventive filter element during installation on a filter press plate 7 is shown in FIG. 5. As can be gathered from FIG. 5, the two filter areas 5, 5′ can be provided on a one-piece filter cloth, which is wrapped round the filter press plate 7.

As is also shown in FIG. 5, the filter element is installed with separated flange elements 10, 10′. During installation the two flange elements 10, 10′ are contacted at a flow opening 8 of filter press plate 7 and are joined to the passage by means of connecting means not shown in FIG. 5.

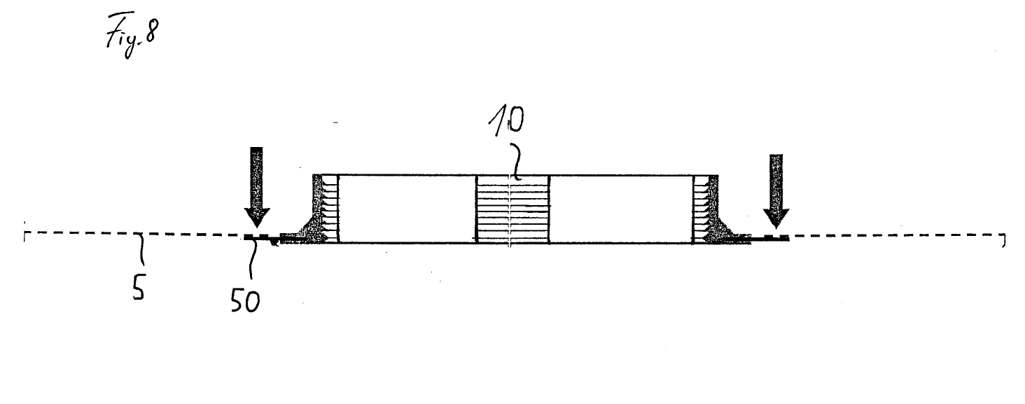

A further embodiment of an inventive filter element for a filter press plate 7 is shown in different installation stages in FIGS. 6 to 11.

FIG. 6 shows a flange element 10 of passage 1 in part sectional, perspective view and FIG. 7 shows the flange element 10 of FIG. 6 in longitudinal section. As can be gathered from FIGS. 6 and 7, a flat, ring-like adapter element 50 is positioned on flange element 10. Said adapter element 50 is made from a different material compared to flange element 10 and projects radially over the flange element 10. As is shown in the part sectional, left-hand area of FIG. 6, there are holes 51 in adapter element 50. Flange element 10 passes through the holes 51 giving a positive connection between flange element 10 and adapter element 50.

Flange element 10 together with adapter element 50 can in particular be produced in a two-stage injection moulding process. The flange element 10 can be produced in the second stage and material of said flange element 10 passes through the holes 51 of the adapter element 50 produced in the first step.

Adapter element 50 can be made from a material having a particularly good compatibility with the filter area 5 to be fitted. The adapter element 50 can e.g. be made from a fabric, a needle-felt, a non-woven fabric, paper, which is made using small thermoplastic fibres, heat and pressure, a film and/or a strong, fibre-free film material and can e.g. be coated with plastic, rubber and/or resin, in order to increase the quality of the connection to filter area 5. Adapter element 50 appropriately has a flexible construction.

FIG. 8 shows a further process step in the production of an inventive filter element. In the process step of FIG. 8 the filter area 5 is placed on adapter element 50 and is connected thereto, e.g. using ultrasonic, hot gas, heating element and/or microwave welding.

The further process for joining together the filter element is shown in FIGS. 9 and 10. As can be gathered there from a connecting tube 20 is provided. Profile elements 42 are located on the inner surface of flange element 10. Said profile elements 42 are grouped in several segments 61 on the surface of flange element 10. In each segment 61 there are preferably several profile elements 42 arranged superimposed in ladder rung-like manner and with a, axial displacement. Profile elements 32 corresponding to profile elements 42 are located on the outer surface of connecting tube 20. Also profile elements 32 are arranged in segments and here again in each segment preferably can be arranged superimposed a plurality of profile elements arranged in ladder rung-like manner and with a superimposed axial displacement. However, it is also possible to have in each segment only one profile element 32 or 42. Profile elements 32 and 42 form a snap closure permitting a sliding of connecting tube 20 into flange element 10 in the direction of the arrow and which blocks a subsequent extraction counter to the arrow direction, however. To bring about a particularly reliable and in particularly tight closure, the wall thickness of connecting tube 20 can be reduced in the vicinity of the at least one profile element 32 and/or the wall thickness of flange element 10 in the vicinity of the at least one profile element 42.

As shown in exemplified manner in FIG. 9, on flange element 10 is provided a positioning element 63 in the form of an axial web. On sliding together said element engages in a not shown, corresponding axial groove on connecting tube 20 and secures a defined rotary position of flange element 10 relative to connecting tube 20.

As can also be gathered from FIGS. 9 and 10, a stop ring 33 is provided externally on connecting tube 20 and limits the axial insertion of connecting tube 20 into flange element 10.

Furthermore, FIGS. 9 and 10 show that on the side of stop 33 remote from profile elements 32 a plurality of further axially displaced profile elements 32′ are provided on the surface of connecting tube 20. Said further profile elements 32′ correspond to the profile elements 42′ in the second flange element 10′ shown in FIG. 11. The corresponding profile elements 32′, 42′ permit an axial mounting of flange element 10′ in the arrow direction shown in FIG. 11 and block an opposing movement. Profile elements 32′, 42′ are appropriately constructed analogously to profile elements 32, 42 and are in particular grouped segmentally.

Also on flange element 10′ is provided a not shown positioning element constructed as an axial web, which during the sliding together engages in a not shown, corresponding axial groove in connecting tube 20 and ensures a defined rotary position of flange element 10′ relative to connecting tube 20.

As can be gathered from FIG. 11, for the subsequent joining together of the filter element the first flange element 10 together with connecting tube 20 is passed through the flow opening 8 in filter press plate 7, filter area 5 abutting on filter press plate 7. The flange element 10′ is then mounted on connecting tube 20 on the side of filter press plate 7 remote from filter area 5 and also filter area 5′ abuts on filter press plate 7 and the two flange elements 10, 10′ are joined to connecting tube 20 to form the finished passage 1. Profile elements 32, 32′, 42, 42′ prevent a subsequent removal of flange elements 10, 10′ from connecting tube 20. If, following the fitting of flange element 10′, connecting tube 20 projects over the flange element 10′, the connecting tube 20 can be shortened, e.g. by cutting off.

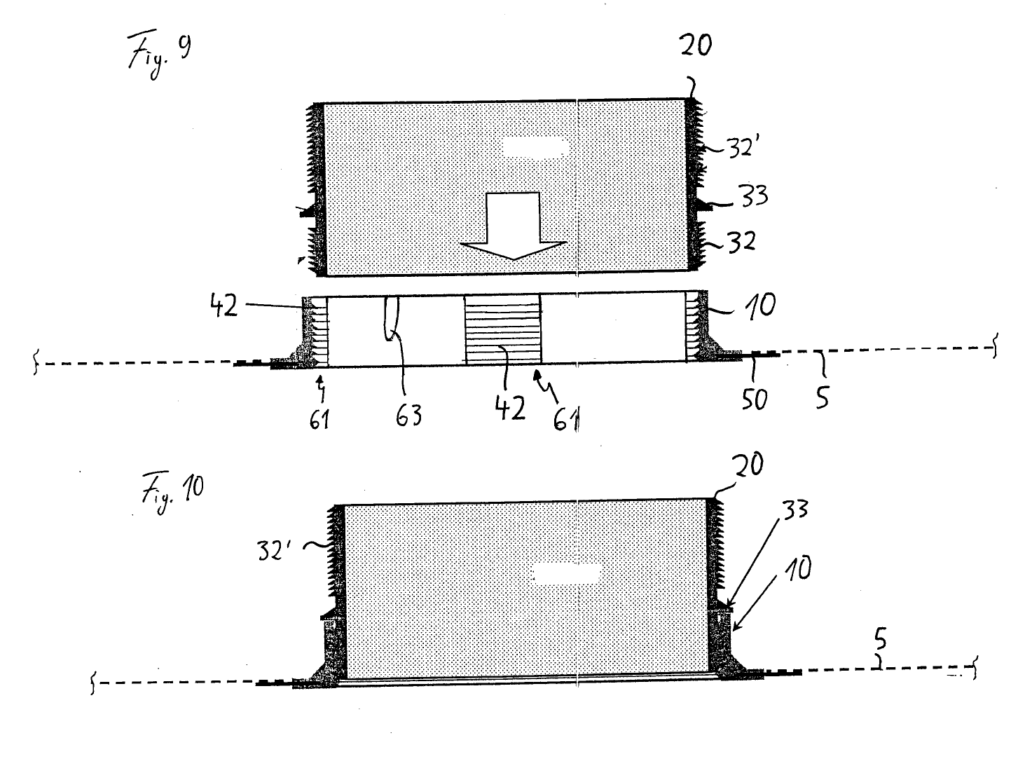

Another embodiment of an inventive filter element is shown in the part longitudinal section of FIG. 12. In the embodiment of FIG. 12 a disk-like flange element 10 is provided. This disk-like flange element 10 is equipped with a recess 44. Through the latter projects a hook-like profile element 34 of the closure device and is positioned frontally on connecting tube 20. Said hook-like profile element 34 maintains flange element 10 on connecting tube 20.

Another embodiment of an inventive filter element is shown in part longitudinal sectional view in FIG. 13. According to the embodiment of FIG. 13 the flange element 10 is designed approximately disk-shaped. For connecting connecting tube 20 to flange element 10 a U-shaped profile element 35 is provided frontally on connecting tube 20. A corresponding U-shaped profile element 45 is located radially inwards on the ring-disk-like flange element 10.

The length of connecting tube 20 can be varied in the embodiment of FIG. 13. For this purpose it is made from a flexible material and has a bellows-like construction. Due to the variable length the filter element can be adapted to different filter plate thicknesses.

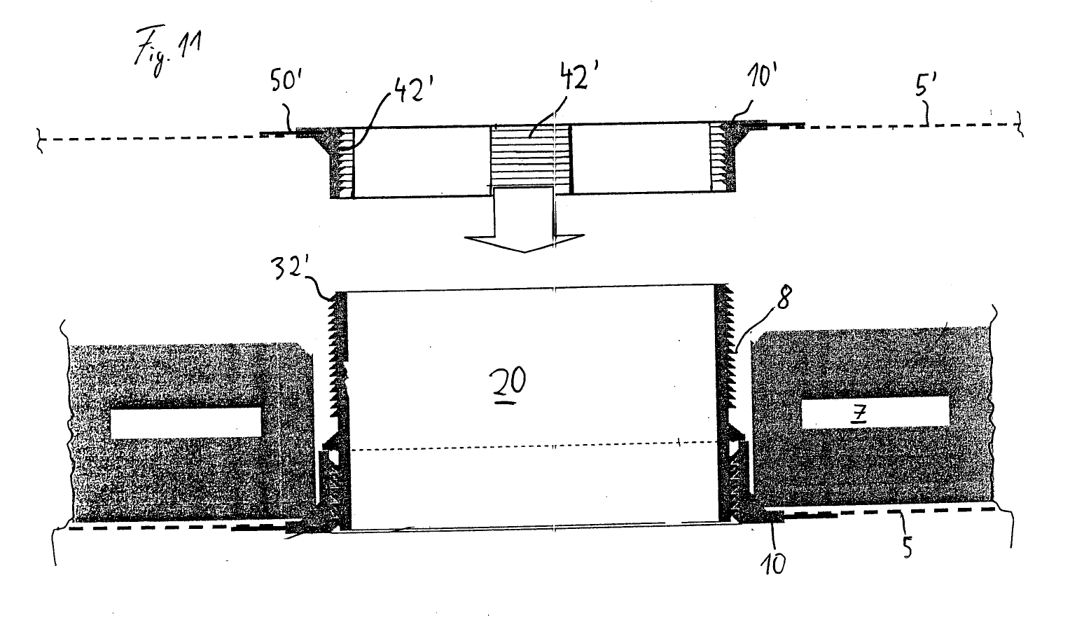

Another embodiment of a passage for an inventive filter element prior to the installation of the two flange elements 10, 10′ is shown in FIG. 14. A bayonet catch is provided for connecting the two flange elements 10, 10′ in the embodiment of FIG. 14. For forming the bayonet catch the connecting means have cylindrical profile elements 36, which project radially on tubular section 18 of flange element 10. Corresponding receptacles 46 for profile elements 36 are provided frontally on tubular section 18′ of the second flange element 10′. These receptacles 46 are constructed as L-shaped notches in tubular section 18′ and permit a fixing of flange element 10 to flange element 10′ by axial insertion of flange element 10 in flange element 10′ and subsequent relative turning.

The flange sections of flange elements 10 and 10′ are given the reference numerals 19 and 19′ respectively.

Tubular section 18 or 18′ of flange elements 10, 10′ can e.g. be made from stainless steel. However, preferably a bicomponent plastic, particularly a TPE-plastic can be used for the flange elements 10, 10′, particularly for their tubular sections 18 and 18′, respectively.

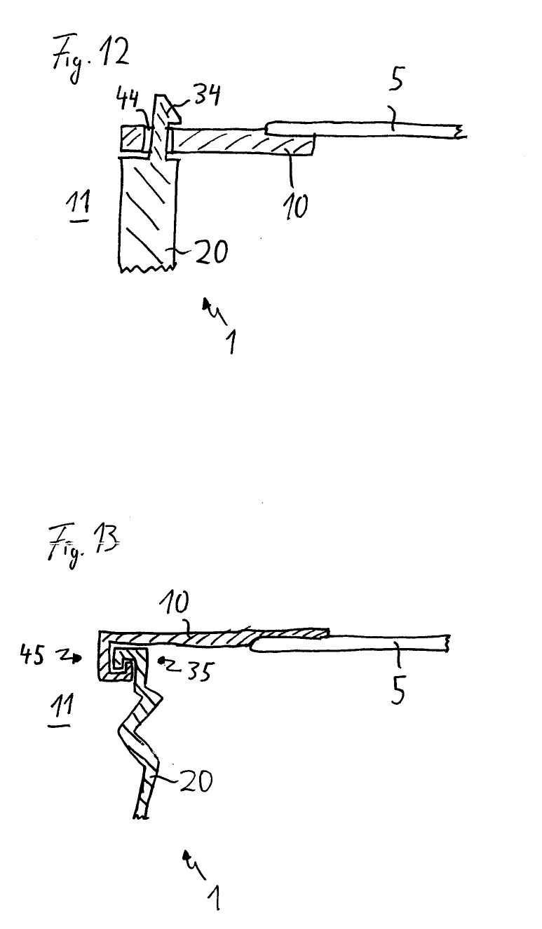

Another embodiment of an inventive filter element is shown in the part sectional view of FIG. 15. In the embodiment of FIG. 15 passage 1 has a flange area 80 on which is located filter area 5, as well as a sleeve-like central area 81 connected to flange area 80. To allow a passage of flange area 80 through a filter plate flow opening not shown in FIG. 15, the passage 1 in flange area 80 is made from a more flexible material than in the central area 81, so that flange area 80 can be deformed.

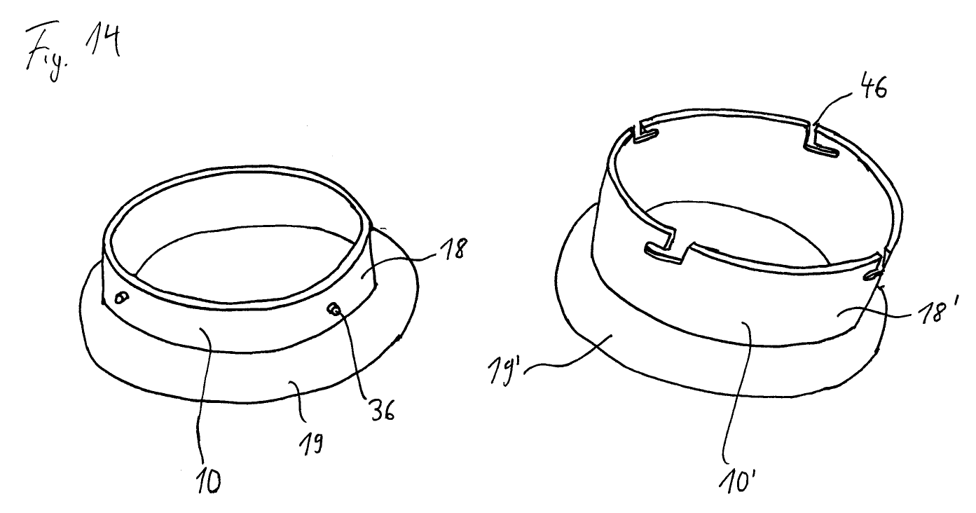

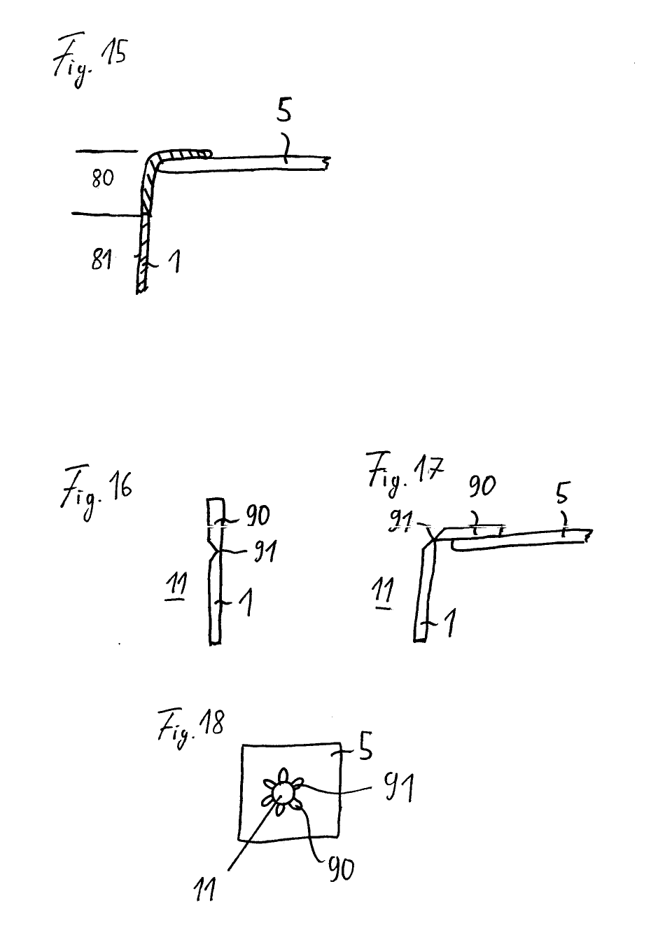

Another embodiment of an inventive filter element is shown in FIGS. 16 to 18. In a sectional partial view FIG. 16 shows the filter element passage 1 prior to the fixing of filter area 5 and FIG. 17 shows the same after fixing filter area 5. FIG. 18 shows a plan view of the filter element after fixing filter area 5.

As can in particular be gathered from FIGS. 16 and 17, frontally on the tubular passage 1 surrounding the passage channel 11 are provided tongues 90, which are articulated to passage 1 by in each case one film hinge 91. For passing the passage through the filter press plate flow opening not shown in FIGS. 16 to 18 the tongues 90 can be brought into the aligned position shown in FIG. 16 in which they do not impede the passing through of passage 1. When the passage 1 has been shoved through the flow opening, as shown in FIGS. 17 and 18, the tongues 90 can be turned over and connected to filter area 5.

1. Filter element for a filter press plate comprising:
two filter areas; and
a passage for passing through a liquid to be filtered and by means of which the two filter areas are interconnected,
wherein—
the passage is constructed in modular manner with at least two separate flange elements, each of said flange elements having a passage opening for the liquid to be filtered and in which one of the two filter areas is positioned on each of the flange elements, and
connecting means are provided with which the two flange elements are inter-connected when the passage openings are aligned.

2. Filter element according to claim 1, wherein the connecting means have a connecting tube on which is located the two flange elements.

3. Filter element according to claim 1, wherein the connecting means are constructed in such a way that the two flange elements, particularly in a clearly defined rotary position, are interconnected in a rotary-fixed manner.

4. Filter element according to claim 2, wherein the flange elements are located radially externally on connecting tube.

5. Filter element according to claim 2, wherein the inner walls of flange elements are at least zonally aligned with an inner wall of connecting tube.

6. Filter element according to claim 1, wherein the connecting means have at least one snap closure.

7. Filter element according to claim 6, wherein the snap closure has a plurality of profile elements, which are positioned radially inwardly on at least one of the flange elements and/or radially outwardly on connecting tube.

8. Filter element according to claim 6, wherein the snap closure has at least one profile element positioned frontally on connecting tube and which preferably projects through one of the flange elements.

9. Filter element according to claim 1, wherein the passage is sealed against liquid passing through radially.

10. Filter element according to claim 2, wherein a sealing element, particularly a sealing ring, is provided between at least one of the flange elements and connecting tube.

11. Filter element according to claim 1, wherein at least one filter area is connected to the passage via a preferably ring-like adapter element.

12. Filter element according to claim 1, wherein for fixing at least one filter area and/or adapter element on passage on the latter is provided at least one retaining spike, which perforates the filter area or adapter element.

13. Filter element according to claim 1, wherein at least one of the flange elements is constructed in two-part form, particularly with a retaining ring and a fixing ring, and that in particular one of the two filter areas and/or the adapter element is received between the two parts and fixed to the flange element.

14. Filter element according to claim 1, wherein both flange elements have an identical construction.

15. Filter element according to claim 1, wherein the passage has a plurality of wall thickness reductions for increasing flexibility.

16. Filter element for a filter press plate, particularly according to claim 1, comprising:
two filter areas; and
a passage for passing through a liquid to be filtered and by means of which the two filter areas are interconnected,
wherein the passage as two terminal flange areas on which are located the filter areas and an intermediate central area and at least in one of the flange areas the passage has a greater flexibility than in the central area.

17. Filter element according to claim 16, wherein the passage in flange area is of different material to that in the central area.

18. Filter element according to claim 16, wherein at least one film hinge is provided for increasing flexibility in flange area.

19. Process for filtering a liquid, wherein the liquid is passed through the filter areas of a filter element according to claim 1.
